(19) United States
(12) Patent Application Publication
(10) Pub. No.: US 2023/0061090 A1
(43) Pub. Date: Mar. 2, 2023

(54) Piecewise Rolled Vector Gratings and Methods of Fabrication

(71) Applicant: DigiLens Inc., Sunnyvale, CA (US)

(72) Inventors: Milan Momcilo Popovich, Leicester (GB); Alastair John Grant, San Jose, CA (US); Roger Allen Conley Smith, Sunnyvale, CA (US); Richard E. Bergstrom, JR., Sunnyvale, CA (US); Hyesog Lee, Sunnyvale, CA (US); Michiel Koen Callens, Sunnyvale, CA (US)

(73) Assignee: DigiLens Inc., Sunnyvale, CA (US)

(21) Appl. No.: 17/822,625

(22) Filed: Aug. 26, 2022

Related U.S. Application Data
(60) Provisional application No. 63/237,422, filed on Aug. 26, 2021.

(51) Int. Cl. G02F 1/1334; G02B 5/32; G03H 1/02

(52) U.S. Cl. CPC G02F 1/13342; G02B 5/32; G03H 1/0248; G02F 2201/30

(57) ABSTRACT

Various embodiments of this disclosure relate to a piecewise varying rolled K-vector grating structure including: a first grating section containing a grating with a first K-vector, a second grating section containing a grating with a second K-vector; and a first boundary region positioned between the first grating section and the second grating section. The first boundary region is a multiplexed grating region including both the first K-vector and the second K-vector. Further disclosed is a method for recording such a grating structure utilizing a holographic recording process. Providing a multiplexed grating in the first boundary region may largely remove line exposure artifacts between adjacent sections of the P-RKV grating.

### CROSS-REFERENCED APPLICATIONS

This application claims priority to U.S. Provisional Application 63/237,422 filed on Aug. 26, 2021, the disclosure of which is incorporated by reference in its entirety.

### FIELD OF THE INVENTION

The present invention generally relates to piecewise varying rolled vector gratings and methods of manufacturing thereof. More specifically, the present invention relates to piecewise varying rolled vector gratings including a multiplexed boundary region.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within or on the surface of the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal (LC) micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for Augmented Reality (AR) and Virtual Reality (VR), compact Heads Up Displays (HUDs) for aviation and road transport, and sensors for biometric and laser radar (LIDAR) applications. As many of these applications are directed at consumer products, there is a growing requirement for efficient low cost means for manufacturing holographic waveguides in large volumes.

### SUMMARY OF THE INVENTION

Many embodiments include a P-RKV grating structure with wide angular bandwidth, high coupling efficiency and improved uniformity. Many embodiments include a low-cost method for fabricating P-RKV grating structures. Many embodiments include P-RKV gratings and methods for their fabrication.

Various embodiments are directed to a grating structure, including: a first grating section containing a grating with a first K-vector providing a first diffraction efficiency versus angle characteristic; a second grating section containing a grating with a second K-vector providing a second diffraction efficiency versus angle characteristic; and a first boundary region positioned between the first grating section and the second grating section, wherein the first boundary region is a multiplexed grating region including both the first K-vector and the second K-vector.

In various other embodiments, the first K-vector and the second K-vector are different.

In still various other embodiments, the grating structure further includes a third grating region containing a grating with a third K-vector providing a third diffraction efficiency versus angle characteristic and a second boundary region separating the second grating region from the third grating region, where the second boundary region is a multiplexed grating region including the second K-vector and the third K-vector.

In still various other embodiments, the second K-vector and the third K-vector are different.

In still various other embodiments, the first and second diffraction efficiency versus angle characteristic have a peak at an angle displaced from the grating on-Bragg diffraction angle.

In still various other embodiments, the first grating section and the second grating section have a spatial variation of at least one selected from the group consisting of: grating thickness, refractive index modulation, grating material composition, concentration of an added dopant, and grating section spatial extent.

In still various other embodiments, the first boundary region has a spatial variation of at least one selected from the group consisting of: grating thickness, refractive index modulation, grating material composition, concentration of an added dopant, and boundary region spatial extent.

In still various other embodiments, the grating structure is a photonic crystal.

In still various other embodiments, the photonic crystal is recorded in holographic polymer dispersed liquid crystal (HPDLC) material.

In still various other embodiments, a liquid crystal is removed after recording of the HPDLC material.

In still various other embodiments, the photonic crystal is formed a holographic photopolymer or a mixture of at least one monomer and at least one liquid crystal.

In still various other embodiments, the first grating section, the first boundary region, and the second grating region are linearly disposed along a given direction.

Various further embodiments are directed to a waveguide display includes a waveguide; and an input coupler, fold grating, or output coupler disclosed within the waveguide, where one or more of the input coupler, fold grating, and/or output coupler include the grating structure described above.

In still various other embodiments, a spatial variation of at least one grating characteristic is tapered near the edge of the first grating section or the second grating section.

Various further embodiments are directed to a method for fabricating a grating structures comprising the steps of: providing a holographic recording material layer; exposing at least a first portion of the holographic recording material layer to a first holographic recording beam to create a first grating section oriented with a first K-vector and a first boundary region partially oriented with the first K-vector; and exposing at least a second portion of the holographic recording material layer to a second holographic recording beam to create a second grating section oriented with a second K-vector and the first boundary region partially oriented with the second K-vector, where the first boundary region is positioned between the first grating section and the second grating section and the first boundary region is a multiplexed grating oriented with the first K-vector and the second K-vector.

In various other embodiments, exposing the holographic recording material layer to the first holographic recording beam and exposing the holographic recording material layer to the second holographic recording beam are performed sequentially.

In still various other embodiments, exposing the holographic recording material layer to the first holographic recording beam and exposing the holographic recording material layer to the second holographic recording beam are performed simultaneously.

In still various other embodiments, the first K-vector and the second K-vector are different.

In still various other embodiments, the holographic recording material layer includes a mixture of at least one monomer and at least one liquid crystal.

In still various other embodiments, the method further includes removing the liquid crystal after exposing the holographic recording material layer.

In still various other embodiments, the method further includes exposing at least a third portion of the holographic recording material layer to a third holographic recording beam to create a third grating section oriented with a third K-vector and a second boundary region partially oriented with the third K-vector, where exposing at least a second portion of the holographic recording material layer further creates a second boundary region partially oriented with the second K-vector, and where the second boundary region is positioned between the second grating section and the third grating section and the second boundary region is a multiplexed grating oriented with the second K-vector and the third K-vector.

In still various other embodiments, the second K-vector and the third K-vector are different.

In still various other embodiments, exposing the holographic recording material layer to the second holographic recording beam and exposing the holographic recording material layer to the third holographic recording beam are performed sequentially.

In still various other embodiments, exposing the holographic recording material layer to the second holographic recording beam and exposing the holographic recording material layer to the third holographic recording beam are performed simultaneously.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 conceptually illustrates a schematic of a P-RKV grating in accordance with an embodiment of the invention.

FIG. 2 is a plot of diffraction efficiency (DE) for a grating containing a single slant angle.

FIG. 3 illustrates a schematic for a P-RKV grating in accordance with an embodiment of the invention.

FIG. 4 conceptually illustrates a 3×3 array of green (520 nm.) input beams.

FIG. 5 shows the corresponding Bragg grating parameters for implementing a continuous RKV grating across the input grating of a waveguide, including the K-vector modulus, and the slant angle.

FIG. 6 is a plan view of a schematic of a P-RKV grating implementing two grating sections with different K-vectors in accordance with an embodiment of the invention.

FIGS. 7-8 show graphs for determining the optimal slant angles to be used in the embodiment of FIG. 6.

FIG. 9 conceptually illustrates the overall effect of providing two K-vectors in a P-RKV grating using the DE versus angle plots of FIGS. 7-8.

FIG. 10A is a plan view of a schematic of the P-RKV grating including three grating regions in accordance with an embodiment of the invention.

FIG. 10B is a plot including the resulting DE versus incidence angle characteristics for each grating of FIG. 10A.

FIG. 11 is a flow chart illustrating a method of fabricating the P-RKV grating of FIG. 1 in accordance with an embodiment of the invention.

FIGS. 12A-12B conceptually illustrate an example process for forming the P-RKV grating illustrated in FIG. 1 in accordance with an embodiment of the invention.

### DETAILED DESCRIPTION

The present disclosure relates to waveguide devices and more particularly to a holographic grating for use in waveguide devices. The angular bandwidth of a grating may be increased by providing a range of slant angles across the beam interaction length of the grating. In some examples, the slant angles can vary in a continuous or stepwise fashion as disclosed in U.S. Pat. No. 9,933,684, entitled “PROVIDING UPPER AND LOWER FIELDS OF VIEW HAVING A SPECIFIC LIGHT OUTPUT APERTURE CONFIGURATION” and filed on Oct. 2, 2013, which is hereby incorporated by reference in its entirety for all purposes. Each slant angle may be associated with a grating or K-vector. Such gratings may be referred to as rolled K-vector (RKV) gratings. A K-vector may be defined as a vector normal to the grating fringes.

The K-vector may have a modulus defined as 2π/Λ where Λ is the grating period (measured along the K-vector direction). RKV gratings may be configured with a constant surface grating spatial frequency to ensure dispersion is corrected between the input and output gratings. U.S. Pat. No. 10,690,916, entitled “APPARATUS FOR PROVIDING WAVEGUIDE DISPLAYS WITH TWO-DIMENSIONAL PUPIL EXPANSION” and filed on Mar. 30, 2018 discloses a waveguide including at least one input coupler, fold grating, or output grating which is a RKV grating. U.S. Pat. No. 10,690,916 is hereby incorporated by reference in its entirety for all purposes. Implementation of the rolled K-vector grating based on the former becomes challenging when a wide range of slant angles is implemented. Various embodiments of the invention relate to RKV gratings with a piecewise variation in K-vector which may be referred to as piecewise varying RKVs (P-RKVs). A P-RKV grating structure may include wide angular bandwidth, high coupling efficiency and improved uniformity. Such wide angular bandwidth and high coupling efficiency may be useful when the grating is utilized as a waveguide input coupler. Some embodiments may include a low-cost method for fabricating P-RKV grating structures.

P-RKVs may suffer from gaps between the grating regions due to practical exposure limitations. The gaps can result in unacceptable illumination artifacts resulting in image nonuniformities. In one particular embodiment of the invention, a P-RKV grating structure may include a plurality of grating sections each characterized by a unique K-vector separated by boundary regions into which are multiplexed the K-vectors of neighboring grating sections. Advantageously, the gratings sections may have the same surface grating period to avoid chromatic dispersion that might otherwise result from a grating period mismatch. Where the P-RKV grating is used as an input coupler in a waveguide, the grating period may also match that of the output grating. Where the P-RKV grating is utilized as a fold grating in a waveguide, the grating periods may satisfy the grating vector closure condition for the input, output, and fold gratings. Providing a multiplexed grating in the boundary regions may largely remove the line exposure artifact between adjacent sections of the P-RKV grating that have been seen in other P-RKV grating implementations. It should also be noted that the angles or shape of each section of the P-RKV grating does not have to align with the grating K-vector, nor with the grating aperture. Therefore, it is possible to specify the prescription of the profile of the P-RKV grating to be most optimal for coupling the full field, with the best overall system uniformity.

Various embodiments of the invention include a method for recording a P-RKV grating in which the exposure of each grating region involves the partial exposure of the boundary region with the K-vector of the grating region being recorded. When the neighboring grating is exposed, the boundary regions is again partially exposed, but this time recording the K-vector of the neighboring grating. The two exposures in the boundary region form a multiplexed (MUX) grating section such that the effective gratings of the neighboring grating sections both extend into the boundary regions and produce an average diffraction efficiency (DE) for light diffraction from the boundary regions. By repeating these steps, P-RKV gratings with any number of elements and K-vector variation can be recorded. The method can also be applied to the recording of P-RKVs in which one or both of the grating section widths or the boundary region widths can vary across the grating. Advantageously, the multiplexed gratings may be recorded sequentially to minimize illumination artifacts that might otherwise result from recording the gratings simultaneously due to competing grating formation processes within the recording material. The latter can occur where a large disparity exists between the slant angles of the multiplexed gratings. One advantage of the process is that P-RKV grating may be implemented from a planar (non-chirped) master by exposing each grating section at a different angle using a spatially traversable recording head. In some embodiments where the grating slant angle difference is more pronounced, the gratings may be recorded simultaneously.

In many embodiments, the P-RKV grating structure can have spatially varying characteristics for tuning the uniformity of the waveguide output. For example, in many embodiments, at least one of grating modulation, thickness variation, grating material composition, grating section spatial extent, and boundary region spatial extent may be used to control uniformity. Material doping in the gaps between P-RKV grating elements may be used for fine-tuning uniformity. In some embodiments, tapered edge uniformity profiles may be used to feather out the grating responses near the edges of the boundary regions to avoid sharp discontinuities in response. In some embodiments, the P-RKV grating can have a uniform thickness. In some embodiments, the relative exposure intensity and hence the modulation across the P-RKV can be varied spatially. In some embodiments, a spatially varying index modulation can be produced by varying the grating formation speed using a light chopper, or some other light interruption means, to modulate the exposure beam illumination intensity.

In many embodiments, the rolled K-vectors may be designed such that the peak diffraction efficiency of each grating segment is optimized for its corresponding output angle at that position. In some embodiments, the peak diffraction efficiency of each grating at different positions may be at an offset with its corresponding output angle at that position. By introducing this offset, eyebox homogeneity can be improved. In some embodiments, offsets can improve total image brightness by a factor of two compared to just matching the peak diffraction efficiencies at different positions.

P-RKVs can be fabricated using modified versions of processes designed for recording RKV Bragg grating in holographic photopolymers and HPDLCs as disclosed in U.S. Pat. Pub. No. 2019/0212699, entitled “Methods for Fabricating Optical Waveguides” and filed Jan. 8, 2019 which is hereby incorporated by reference in its entirety. In one class of gratings formed in monomer and liquid crystal mixtures, LC can be removed after curing to form an evacuated periodic structure. Examples of evacuated periodic structures and methods of manufacturing evacuated periodic structures are disclosed in U.S. Pat. Pub. No. 2021/0063634, entitled “Evacuating bragg gratings and methods of manufacturing” and filed on Aug. 28, 2020, which is hereby incorporated by reference in its entirety. An ashing process may be used to remove polymerization residues. Examples of an ashing process and gratings produced via ashing are described in PCT Pub. No. WO2022015878, entitled “Nanoparticle-based holographic photopolymer materials and related applications” and filed Jul. 14, 2021, which is hereby incorporated by reference in its entirety. However, the ashing process used to remove polymerization residues from such gratings may be difficult to apply to the overlapping modulations of the multiplexed gratings formed in the boundary regions. In some embodiments, the grating structure can be formed from HPDLC photonic crystals based on grating structures comprising elongate diffracting nodes (e.g. nodes of cylindrical shape) to provide multiplexed gratings structures that may be more accessible to finishing using ashing processes as disclosed in PCT App. No. PCT/US2022/071007, entitled “Evacuated Periodic Structures and Methods of Manufacturing” and filed Mar. 7, 2022, which is hereby incorporated by reference in its entirety.

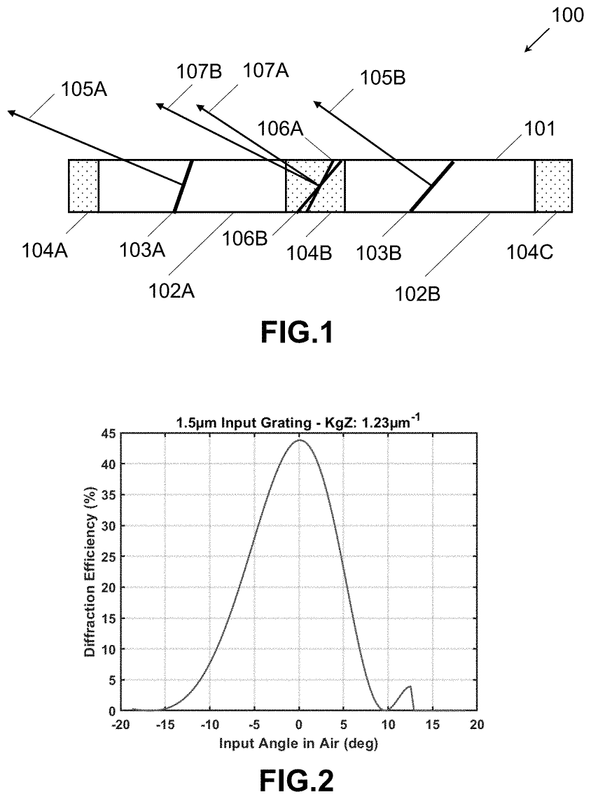

FIG. 1 conceptually illustrates a schematic of a P-RKV grating in accordance with an embodiment of the invention. The grating 100 includes a portion 101 of a holographic layer into which two grating sections 102A,102B are recorded with two fringes 103A,103B to create a first K-vector 105A for the first grating section 102A and a second K-vector 105B for the second grating section. The first K-vector 105A and the second K-vector 105B may be normal to the surface of the fringes 103A,103B. The first grating section 102A is disposed between the boundary regions 104A and 104B and the second grating section 102B is disclosed between the boundary regions 104B and 104C. Each boundary region multiplexes the grating sections 102A,102B,102C on either side of it. Hence the boundary region 104B multiplexes gratings with different orientations 106A,106B to create K-vectors 107A,107B which are parallel to the K-vectors 105A,105B respectively. The boundary regions 104A,104B,104C may be multiplexed grating regions which each include multiple K-vectors 107A,107B. The K-vectors 107A,107B for each of the boundary regions 104A,104B,104C may be parallel to K-vectors of the grating sections 102A,102B,102C which surround that specific boundary region.

The boundary region 104B contains the grating recorded into the grating sections 102A,102B on either side of the boundary region 104B, each section being exposed to recording beams that overfill the section and extend across the entirety of the boundary region 104B. The two gratings formed in the boundary region 104B provide a multiplexed grating (e.g. two gratings integrated together within a single layer). The multiplexed grating can arise from the recording beams which form the grating sections 102A,102B on either side being exposed either sequentially or simultaneously. For example, the recording beam for each adjacent grating section 102A, 102B can be recorded simultaneously. In the case of sequential recording it may be beneficial to control the two exposures (illumination intensity and duration) such that the first grating in the boundary region 104B is partially formed without completely depleting the available recording material, to permit recording of the second grating in the boundary region 104B. The exposure conditions may also be controlled to ensure that the growth of modulation of the first grating in the boundary region 104B does not inhibit the diffusion processes for forming the second grating in the boundary region 104B. In the case of simultaneous exposure, one grating may gain modulation at the expense of the other grating in the boundary region 104B. In general, simultaneous multiplexed grating recording may be most effective when the grating vectors of the gratings in the boundary region 104B to be multiplexed are symmetrically disposed about the normal to the holographic layer. While it is discussed in connection with two grating sections 102A,102B and the surrounded boundary region 104B it is understood that the same multiplexed gratings may be formed in the other boundary regions 104A,104C which may be formed through the two grating sections 102A,102B and other surrounding unillustrated grating sections.

FIG. 2 is a plot of diffraction efficiency (DE) for a grating containing a single slant angle. The grating is configured as a waveguide input grating for an input field of view (FOV) of 26.15° H×18° V. The grating is oriented such that the K-vector is nearly parallel with the horizontal dimension of the FOV. With an input grating using a single slant angle across the entire grating, the field rays on the edges may not be carried by the waveguide. It may be beneficial to implement a system to capture the edge rays and improve overall system uniformity.

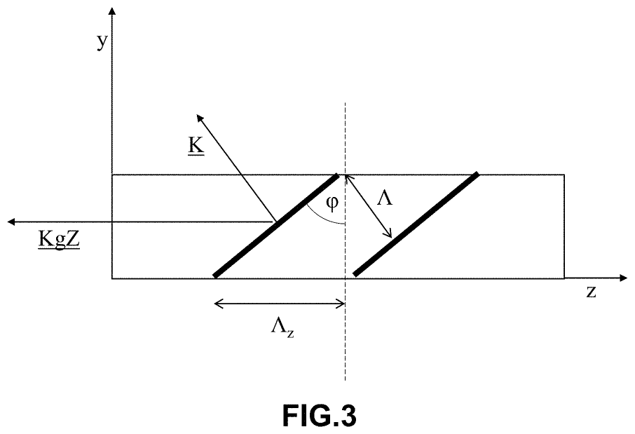

FIG. 3 illustrates a schematic for a P-RKV grating in accordance with an embodiment of the invention. The grating K-vector (K) and the component of the K-vector in the waveguide plane (KgZ). The K-vector has a modulus equal to 2π/Λ where Λ is the fringe spacing in a direction normal to the fringe surfaces. The vector component KgZ, which is in the z direction has a modulus given by Λ_{z}=Λ/cos(φ) where φ is the grating slant angle (which is in the plane of the drawing). Thus, the slant angle φ is directly related to the orientation of the K-vector K. Also, the KgZ is directly related to the magnitude of the K-vector. It is understood that the slant angle φ and the KgZ may be used to calculate the K-vector K. The vector component KgZ can also be expressed as KgZ=Λ_{z}*z, where z is a unit vector in the z-direction.

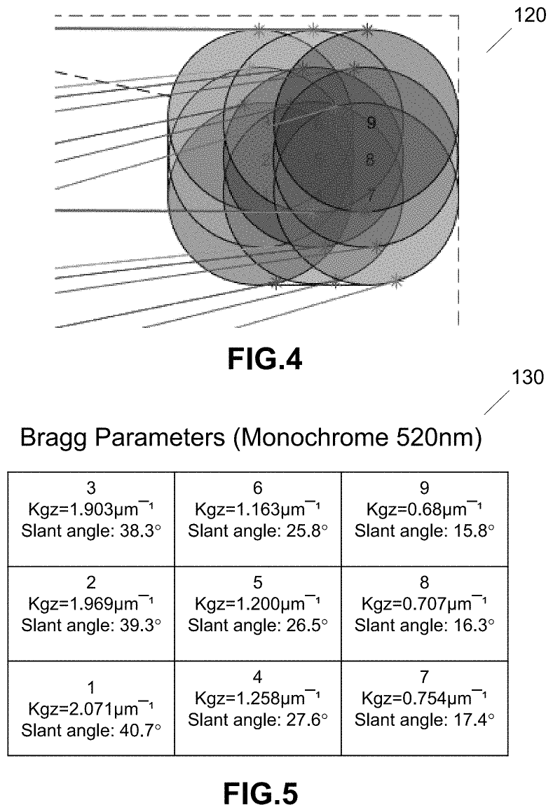

FIGS. 4-5 illustrate examples of Bragg parameters for a wide FOV grating. Wide FOV waveguides may include a RKV input grating. FIG. 4 conceptually illustrates a 3×3 array of green (520 nm.) input beams labelled 1-9. FIG. 5 shows the corresponding Bragg grating parameters for implementing a continuous RKV grating across the input grating of a waveguide, including the K-vector modulus, and the slant angle. The KgZ is the magnitude of the K-vector in the z direction. The KgZ may be calculated by 2π divided by the grating fringe spacing along the normal to the Bragg fringes. The KgZ is independent of the direction of the vector. KgZ is the projection of the K-vector modulus into the grating plane along the Z axis. The broad range of incident angles may include different slant angles across the input grating from 15.8° to 40.7°. As discussed above, the KgZ and the slant angle may be used to calculate the K-vector. Thus, different KgZ and slant angle for different sections makes different K-vectors for different sections.

As shown by the table in FIG. 5, providing a continuous RKV across the input grating is technically challenging and problematic for volume production of gratings. In FIG. 5, the slant angles range between 15.8 degrees and 40.7 degrees. Such a large range makes it difficult to record a continuously varying slant angle within sufficient input beams directional specificity resulting in aberrations and illumination nonuniformity in the final waveguide display. The piecewise grating approach may allow the exposure beam configuration to be simplified by configuring each grating elements for some optimal angular range. The P-RKV prescription may, in many embodiments, be determined using reverse ray tracing. Instead of a full RKV grating, a P-RKV grating may be implemented to improve the DE and field uniformity with an acceptable level of complication of the exposure apparatus and process. Input designs utilizing 2 K-Vector P-RKV grating and 3 K-vector P-RKV grating are discussed below.

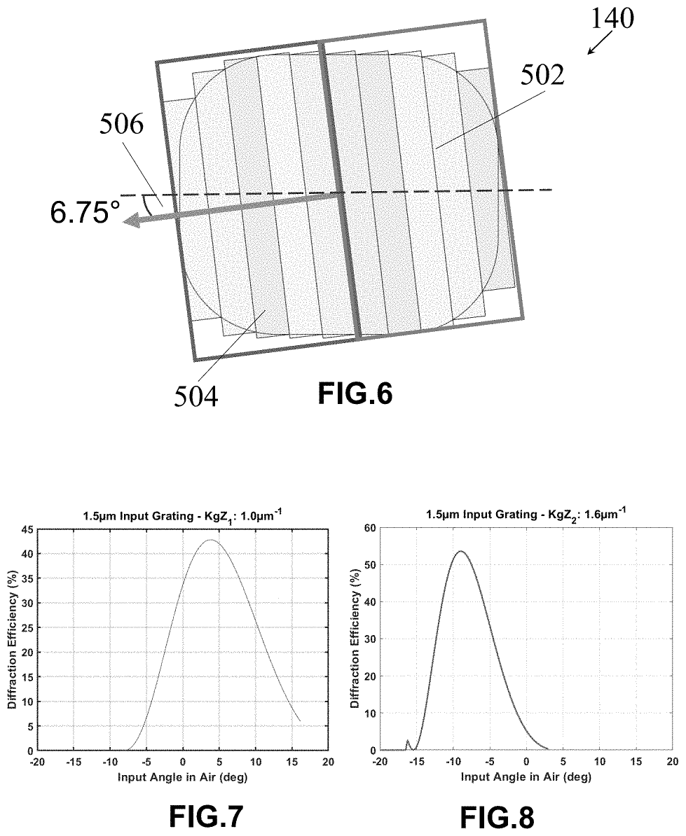

FIG. 6 is a plan view of a schematic of a P-RKV grating implementing two grating sections with different K-vectors in accordance with an embodiment of the invention. The grating period (e.g. 0.415 μm) may be constant across the entire input grating with only 1 master grating with a constant period. The P-RKV grating 140 may be clocked with a clocking angle 506 of 6.75°. The clocking angle 506 may be the angle between the projected K-vector of each grating section and some arbitrary coordinate (for example, the horizontal axis shown as a dash line in FIG. 6). The P-RKV grating 140 may include a first grating section 502 which includes a first K-vector. The first grating section 502 may be exposed with one slant angle, in a plane orthogonal to the grating plane and containing the z-component of the grating vector. The first grating section 502 may include a first KgZ. The P-RKV grating 140 may include a second grating section 504 which includes a second K-vector different from the first K-vector. The second grating section 504 may be exposed with a different slant angle, in a plane orthogonal to the grating plane and containing the z-component of grating vector. The second grating section 504 may include a second KgZ different from the first KgZ.

The slant angle is the tilt angle of a Bragg fringe within a plane orthogonal to the grating plane. The K-vector is the normal to the Bragg fringe, specifying a slant angle is equivalent to specifying a K-vector. The grating section 502 comprises grating strips having a common K-vector/slant angle (and similarly for the grating section 504). Note that various conventions may be used for defining the angle depending on the coordinate frame used to define the grating. A K-vector is a more useful parameter since it specifies the grating orientation in 3D space whereas a slant angle only applies in one plane and requires further information on the plane rotation within the grating plane. K-vectors result in more computationally efficient ray-tracing algorithms and can be used in reciprocal lattice formulations of grating theory.

The values of the z-components of the grating vector of the first grating section 502 and the second grating section 504 may be chosen to allow for peak offset from center of input angular bandwidth. The values of the z-components of the grating vector refers to the z component of the modulus of the grating K-vector, where the z-axis corresponds to the drawing horizontal direction.

FIGS. 7-8 show graphs for determining the optimal slant angles to be used in the embodiment of FIG. 6. The first grating section 502 may include smaller slant angles, between 15.8° and 26.5° with KgZ values between 0.68 μm⁻¹ and 1.2 μm⁻¹. The left side of the field may include higher slant angles between 26.5° and 40.7°, resulting in KgZ values between 1.2 μm⁻¹ and 2.071 μm⁻¹. KgZ is the projection of the modulus of the K-vector onto the grating plane along the Z coordinate. If the fringe spacing along the K-vector is Kg, the KgZ is given by Kg multiplied by the cosine of the angle between the K-vector and the grating plane (within a plane orthogonal to the grating plane and along the Z coordinate). FIG. 7 shows the DE versus input angle in air (deg.) for an example input grating include a 1.5-micron thickness with KgZ=1.0 μm⁻¹, which provides good coverage for the right side of the field. FIG. 8 shows the DE versus input angle in air (deg.) for an example input grating including a 1.5-micron thickness with KgZ=1.6 μm⁻¹, which provides good coverage for the left side of the field.

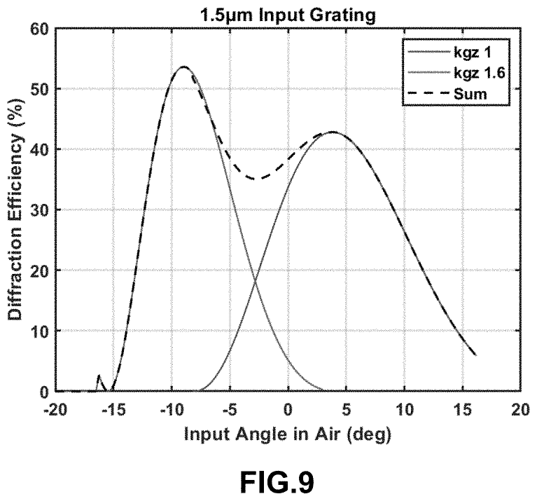

FIG. 9 conceptually illustrates the overall effect of providing two K-vectors in a P-RKV grating using the DE versus angle plots of FIGS. 7-8. The combination of both DE profiles (represented by the dashed line) may result in an average DE of 37.7% and an overall uniformity of 26.9%.

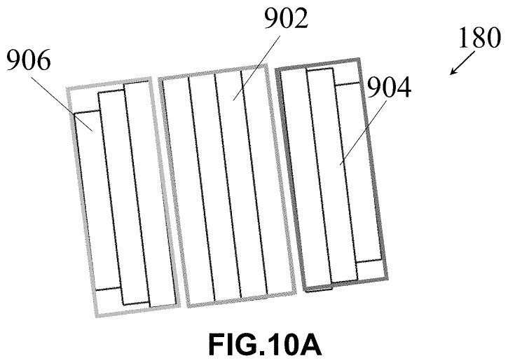

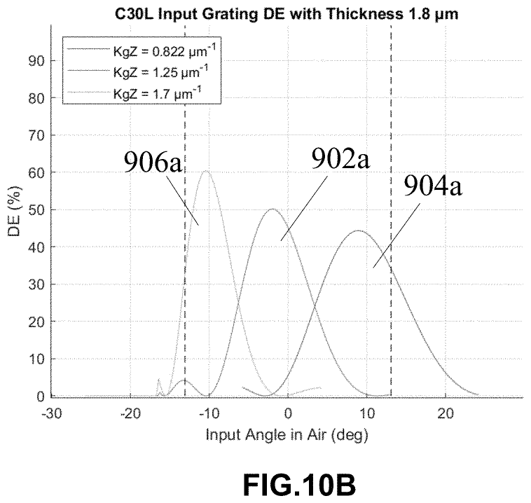

Although the description has referred to grating structures using two grating sections, one of ordinary skill would understand that a P-RKV grating can include any number of sections with different slant angles. For example, FIGS. 10A-10B show an example P-RKV grating with a three grating region configuration. FIG. 10A is a plan view of a schematic of the P-RKV grating including three grating regions in accordance with an embodiment of the invention. As illustrated, the P-RKV grating 180 includes a first grating section 902, a second grating section 904, and a third grating section 906. FIG. 10B is a plot including the resulting DE versus incidence angle characteristics for each grating of FIG. 10A. A first curve 902a corresponds to the first grating section 902, a second curve 904a corresponds to the second grating section 904, and a third curve 906a corresponds to the third grating section 906. As explained above, using three grating sections, characterized by three different KgZ values, allows the use of thicker input gratings with higher DE over the entire input field. The three grating sections have three different KgZ values resulting from projecting three different K-vectors onto the grating plane along the Z axis according to the principles discussed above.

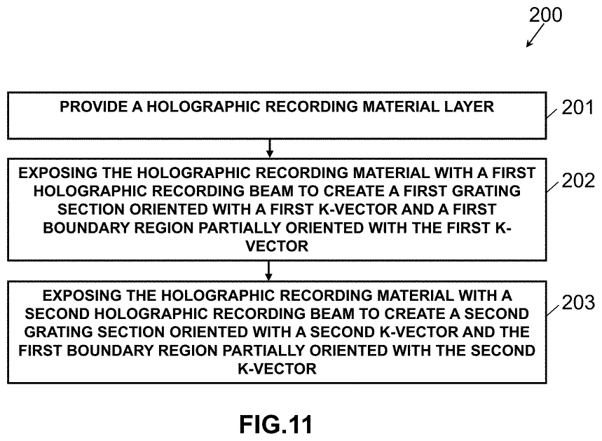

FIG. 11 is a flow chart illustrating a method of fabricating the P-RKV grating of FIG. 1 in accordance with an embodiment of the invention. As shown, a method 200 of fabricating a P-RKV grating is provided. The method 200 includes providing (201) a holographic recording material layer. The method further includes exposing (202) the holographic recording material layer through a first holographic recording beam to create a first grating section oriented with a first K-vector and a first boundary region partially oriented with the first K-vector. The method 200 further includes exposing (203) the holographic recording material layer to a second holographic recording beam to create a second grating section oriented with a second K-vector and the first boundary region partially oriented with the second K-vector. As described in connection with FIG. 1, the first boundary section is positioned between the first grating section and the second grating section. The first boundary region is a multiplexed grating oriented with the first K-vector and the second K-vector. The first K-vector and the second K-vector may be different (e.g. not parallel).

In some embodiments, exposing the holographic recording material layer to the first holographic recording beam and exposing the holographic recording material layer to the second holographic recording beam are performed sequentially. In some embodiments, exposing the holographic recording material layer to the first holographic recording beam and exposing the holographic recording material layer to the second holographic recording beam are performed simultaneously. The holographic recording material layer may include a mixture of at least one monomer and at least one liquid crystal. The liquid crystal may be removed after exposing the holographic recording material layer to create an evacuated periodic structure as discussed above.

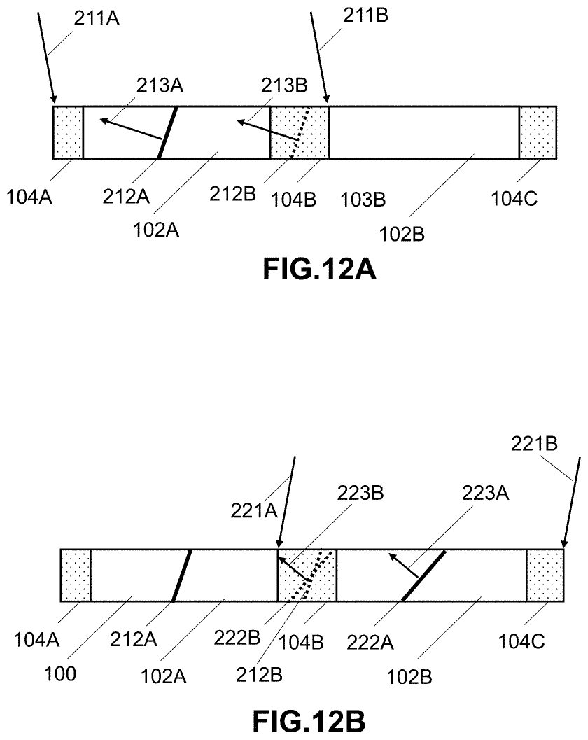

FIGS. 12A-12B conceptually illustrate an example process for forming the P-RKV grating illustrated in FIG. 1 in accordance with an embodiment of the invention. FIG. 12A conceptually illustrates a first exposure step exposing the first grating section 102A and the adjoining boundary regions 104B,104A with a first recording beam. The exposure beam may be produced by a master grating. The exposure beam may have a lateral extent bounded by rays 211A,211B, resulting in the exposure of the first grating section 102A and boundary regions 104A,104B to form gratings 212A,212B having an identical first K-vector 213A,213B.

FIG. 12B conceptually illustrates a second exposure step exposing the second grating section 102B and the adjoining boundary regions 104B,104C with a second recording beam. Gratings 222A,222B may be formed having an identical second K-vector 223A,223B. The second recording beam is bounded by rays 221A,221B which extend across the second grating section 102B and the boundary regions 104B,104C. As discussed above, the first recording beam and the second recording beam may be applied sequentially or simultaneously. The first grating section 102A may include the first K-vector and the second grating section 102B may include the second K-vector. As illustrated, the boundary region 104B between the first grating section 102A and the second grating section 102B may be formed as a multiplexed grating including the first K-vector and the second K-vector. The first K-vector and the second K-vector may be different orientation.

In some embodiments, the P-RKV gratings may be exposed using a wide range of holographic processes, including processes using master gratings, contact replication processes, scanned laser exposure, and/or inkjet-printed grating exposure applied to holographic material layers of any size and geometry. In some embodiments, neighboring grating sections 102A,102B and adjacent boundary regions 104A,104B,104C can be exposed sequentially or simultaneously. While, two grating sections 102A,102B are illustrated, it is considered within the scope of the disclosure that more adjacent grating sections may be present. The additional adjacent grating sections may be exposed sequentially or simultaneously. For example, each of the first grating section 102A, the second grating section 102B, and the additional adjacent grating sections may be exposed separately. Further, each of the first grating section 102A, the second grating section 102B, and the additional adjacent grating sections may be exposed simultaneously such that multiple recording beams with different orientations are applied to different sections of a holographic recording material. The boundary regions 104A,104B,104C may be multiplexed with multiple orientations of recording beams being applied to the boundary regions 104A,104B,104C.

The construction and arrangement of the systems and methods as shown in the various exemplary embodiments are not limiting. It has been contemplated that many modifications are possible (for example, variations in sizes, dimensions, structures, shapes, and proportions of the various elements, values of parameters, mounting arrangements, use of materials, colors, orientations, etc.). Further, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A grating structure, comprising:
a first grating section containing a grating with a first K-vector providing a first diffraction efficiency versus angle characteristic;
a second grating section containing a grating with a second K-vector providing a second diffraction efficiency versus angle characteristic; and
a first boundary region positioned between the first grating section and the second grating section,
wherein the first boundary region is a multiplexed grating region including both the first K-vector and the second K-vector.

2. The grating structure of claim 1, wherein the first K-vector and the second K-vector are different.

3. The grating structure of claim 1, further comprises a third grating region containing a grating with a third K-vector providing a third diffraction efficiency versus angle characteristic and a second boundary region separating the second grating region from the third grating region, wherein the second boundary region is a multiplexed grating region including the second K-vector and the third K-vector.

4. The grating structure of claim 3, wherein the second K-vector and the third K-vector are different.

5. The grating structure of claim 1, wherein the first grating section and the second grating section have a spatial variation of at least one selected from the group consisting of: grating thickness, refractive index modulation, grating material composition, concentration of an added dopant, and grating section spatial extent.

6. The grating structure of claim 1, wherein the first boundary region has a spatial variation of at least one selected from the group consisting of: grating thickness, refractive index modulation, grating material composition, concentration of an added dopant, and boundary region spatial extent.

7. The grating structure of claim 1, wherein the grating structure is formed from a holographic photopolymer or a mixture of at least one monomer and at least one liquid crystal.

8. The grating structure of claim 1, wherein the first grating section, the first boundary region, and the second grating region are linearly disposed along a given direction.

9. A waveguide display comprising:
a waveguide; and
an input coupler, fold grating, or output coupler disclosed within the waveguide,
wherein one or more of the input coupler, fold grating, and/or output coupler include the grating structure of claim 1.

10. The grating structure of claim 1, wherein a spatial variation of at least one grating characteristic is tapered near the edge of the first grating section or the second grating section.

11. A method for fabricating a grating structures comprising the steps of:
providing a holographic recording material layer;
exposing at least a first portion of the holographic recording material layer to a first holographic recording beam to create a first grating section oriented with a first K-vector and a first boundary region partially oriented with the first K-vector; and
exposing at least a second portion of the holographic recording material layer to a second holographic recording beam to create a second grating section oriented with a second K-vector and the first boundary region partially oriented with the second K-vector,
wherein the first boundary region is positioned between the first grating section and the second grating section and the first boundary region is a multiplexed grating oriented with the first K-vector and the second K-vector.

12. The method of claim 11, wherein exposing the holographic recording material layer to the first holographic recording beam and exposing the holographic recording material layer to the second holographic recording beam are performed sequentially.

13. The method of claim 11, wherein exposing the holographic recording material layer to the first holographic recording beam and exposing the holographic recording material layer to the second holographic recording beam are performed simultaneously.

14. The method of claim 11, wherein the first K-vector and the second K-vector are different.

15. The method of claim 11, wherein the holographic recording material layer comprises a mixture of at least one monomer and at least one liquid crystal.

16. The method of claim 15, further comprising removing the liquid crystal after exposing the holographic recording material layer.

17. The method of claim 11, further comprising exposing at least a third portion of the holographic recording material layer to a third holographic recording beam to create a third grating section oriented with a third K-vector and a second boundary region partially oriented with the third K-vector,
wherein exposing at least a second portion of the holographic recording material layer further creates a second boundary region partially oriented with the second K-vector, and
wherein the second boundary region is positioned between the second grating section and the third grating section and the second boundary region is a multiplexed grating oriented with the second K-vector and the third K-vector.

18. The method of claim 17, wherein the second K-vector and the third K-vector are different.

19. The method of claim 17, wherein exposing the holographic recording material layer to the second holographic recording beam and exposing the holographic recording material layer to the third holographic recording beam are performed sequentially.

20. The method of claim 17, wherein exposing the holographic recording material layer to the second holographic recording beam and exposing the holographic recording material layer to the third holographic recording beam are performed simultaneously.
